(19) United States
(12) Patent Application Publication
(10) Pub. No.: US 2002/0109783 A1
(43) Pub. Date: Aug. 15, 2002

(54) Electronic still camera

(75) Inventors: Masaki Hayashi, Chiba-shi (JP); Kazuyuki Kazami, Itabashi-ku (JP)

Correspondence Address: OLIFF & BERRIDGE, PLC, P.O. BOX 19928, ALEXANDRIA, VA, 22320, US

(73) Assignee: NIKON CORPORATION, Tokyo (JP)

(21) Appl. No.: 09/998,772

(22) Filed: Dec. 3, 2001

Related U.S. Application Data
(63) Continuation of application No. PCT/JP00/03396, filed on May 26, 2000.

(30) Foreign Application Priority Data
Jun. 2, 1999 (JP) 11-155633

(51) Int. Cl. H04N 5/222

(52) U.S. Cl. 348/333.05

(57) ABSTRACT

An electronic still camera includes: an image capturing element which captures an image of a photographic subject via a photographic lens, and which outputs the image of the photographic subject which has been captured as image data; a storage device which stores at least two sets of image data having different image capture timings; a display device which displays an photographic subject image which has been converted into image data; and a display control circuit which, during photography, causes at least two photographic subject images based respectively upon the two sets of image data to be displayed upon the display device in different regions thereof.

This application is a continuation of PCT Application No. PCT/JP00/03396 filed May 26, 2000.

### INCORPORATION BY REFERENCE

The disclosures of the following applications are herein incorporated by reference:

Japanese Patent Application No. H11-155633 filed on Jun. 2, 1999; and

PCT Application No. PCT/JP00/03396 filed on May 26, 2000.

### BACKGROUND OF THE INVENTION

1. Field of the Invention

The present invention relates to an electronic still camera which captures an image of a photographic subject electronically and records it as image data.

2. Description of the Related Art

From the past there has been known a digital camera which comprises a focus detection and adjustment device which performs focus detection by driving a photographic lens, an image capturing device such as a CCD which captures an image of a photographic subject through the photographic lens and outputs it as image data, an image processing circuit which performs image processing such as white balance adjustment and gamma correction and the like upon the image data which is outputted from the image capturing device, a monitor which displays this data after image processing, and a compression circuit which compresses this data after image processing in a format like the JPEG format or the like and then records it upon a recording medium such as a flash memory or the like.

When photographic operation is performed with a prior art digital camera of this type, an image of the photographic subject is photographed by shutter release actuation, image processing is performed upon the image data which is outputted from the image capturing device by performing white balance adjustment and/or gamma correction and the like, and the image which has been photographed is displayed upon the monitor as a so called freeze frame. And compression processing is performed to compress this data after the image processing, and recording processing is performed to record the compressed data upon the recording medium, and then the photographic process is terminated.

The photographic subject image which is displayed upon the monitor automatically changes over to a so called “through frame” real time image before photography, when a predetermined time period has elapsed from when the freeze frame was displayed. For example, the display may change over to the through frame display when the photographic data has been compressed and has been stored in the memory card. Accordingly the problem is experienced that it is not possible to cause the directly previous photographic image to be displayed upon the monitor after the monitor display of the camera has changed over from the freeze frame screen to the through frame screen.

### SUMMARY OF THE INVENTION

Accordingly it is the objective of the present invention to provide an electronic still camera which is capable of simultaneously displaying the image which was photographed directly before, during the display of a through frame before photography.

In order to attain the above objective, an electronic still camera according to the present invention comprises: an image capturing element which captures an image of a photographic subject via a photographic lens, and which outputs the image of the photographic subject which has been captured as image data; a storage device which stores at least two sets of image data having different image capture timings; a display device which displays an photographic subject image which has been converted into image data; and a display control circuit which, during photography, causes at least two photographic subject images based respectively upon the two sets of image data to be displayed upon the display device in different regions thereof.

In this electronic still camera, it is preferred that: an image size compression circuit which compresses an image size of image data for displaying a photographic subject image upon the display device is further provided; and the image size compression circuit compresses image sizes of the two sets of image data into two different sizes while maintaining aspect ratios of the image sizes of the two sets of image data constant. In this case, it is preferred that the image size compression circuit makes the image size of the photographic subject image which is being captured by the image capturing element to be larger, than the image size of the photographic subject image which has been captured upon shutter release actuation.

Also, it is preferred that one of the two sets of image data is a photographic subject image which has been captured upon shutter release actuation, and the other is a photographic subject image which is being captured by the image capturing element.

Also, it is preferred that: a selection device which selects a recording mode in which, upon shutter release actuation, a photographic subject image is captured and image data is recorded, and a replay mode in which image data which has been recorded in recording mode is displayed upon the display device, is further provided; and if the recording mode is selected by the selection device, the display control circuit displays the at least two photographic subject images based respectively upon the two sets of image data upon the display device in different regions thereof. In this case, it is preferred that: a recording medium, separate from the storage device, upon which image data is recorded, is further provided; and the recording medium records image data during the recording mode, and reads out image data which has been recorded during the replay mode.

Also, it is preferred that the display device is provided within the same chassis as the electronic still camera.

Another electronic still camera according to the present invention comprises: an image capturing element which captures an image of a photographic subject via a photographic lens, and which outputs the image of the photographic subject which has been captured as image data; a storage device which stores at least two sets of image data having different image capture timings; a display device which displays an photographic subject image which has been converted into image data; and a display control circuit which, during photography, provides a display upon the display device which is changeable over between a multi image display in which at least two photographic subject images based respectively upon the two sets of image data are displayed, and a single image display in which one or the other of the at least two photographic subject images based respectively upon the two sets of image data is displayed.

In this electronic still camera, it is preferred that a selection device which selects either the multi image display or the single image display is further provided. In this case, it is preferred that: a time measurement circuit which times a time period during which the multi image display is performed, is further provided; and in a case that the multi image display is selected by the selection device, the display control circuit stops the multi image display and changes over to the single image display, when a predetermined time period after the multi image display has been selected has been timed by the time measurement circuit. Also, it is preferred that: a decision circuit which decides whether or not at least half press shutter release actuation has been performed, is further provided; and in a case that the multi image display is selected by the selection device, the display control circuit stops the multi image display and changes over to the single image display, when it has been decided by the decision circuit that half press shutter release actuation has been performed.

Also, it is preferred that one of the two sets of image data is a photographic subject image which has been captured upon shutter release actuation, and the other is a photographic subject image which is being captured by the image capturing element.

Also, it is preferred that: a selection device which selects a recording mode in which, upon shutter release actuation, an image of a photographic subject is captured and image data is recorded, and a replay mode in which image data which has been recorded in recording mode is displayed upon the display device, is further provided; and if the recording mode is selected by the selection device, the display control circuit provides a display upon the display device which is changeable over between a multi image display in which at least two photographic subject images based respectively upon the two sets of image data are displayed, and a single image display in which one or the other of the at least two photographic subject images based respectively upon the two sets of image data is displayed. In this case, it is preferred that: a recording medium, separate from the storage device, upon which image data is recorded, wherein the recording medium records image data during the recording mode, and reads out image data which has been recorded during the replay mode, is further provided.

Also, it is preferred that the display device is provided within the same chassis as the electronic still camera.

### BRIEF DESCRIPTION OF THE DRAWINGS

FIGS. 1A and 1B are views showing the exterior of a digital still camera according to a preferred embodiment of the present invention in its unused and portable state, with FIG. 1A being a view as seen from above, while FIG. 1B is a view as seen from the rear.

FIGS. 2A, 2B, and 2C are views showing the exterior of this digital still camera according to this preferred embodiment of the present invention in its state as ready for normal photography, with FIG. 2A being a view as seen from the front, FIG. 2B being a view as seen from above, and FIG. 2C being a view as seen from the rear.

FIG. 3 is a block diagram for this digital still camera according to this preferred embodiment of the present invention.

FIGS. 4A, 4B, and 4C are figures for explanation of menu setting screens for the photographic mode of this digital still camera according to this preferred embodiment of the present invention, with FIG. 4A showing a photographic menu screen, FIG. 4B showing an AF operation setting screen, and FIG. 4C showing a simultaneous display setting screen.

FIG. 5 is a figure for explanation of a setting screen for shutter speed, aperture value, and exposure correction value of this digital still camera according to this preferred embodiment of the present invention.

FIG. 6 is a flow chart for explanation of a main processing routine for photographic mode, performed by this digital still camera according to this preferred embodiment of the present invention.

FIG. 7 is a flow chart for explanation of a routine for image pre-processing, performed by this digital still camera according to this preferred embodiment of the present invention.

FIG. 8 is a flow chart for explanation of a routine for display processing, performed by this digital still camera according to this preferred embodiment of the present invention.

FIG. 9 is a flow chart for explanation of a routine for composite processing, performed by this digital still camera according to this preferred embodiment of the present invention.

FIG. 10 is a figure for explanation of a map in a buffer memory of this digital still camera according to this preferred embodiment of the present invention, when “picture in picture” display is being performed.

FIG. 11 is a figure for explanation of this map in the buffer memory of this digital still camera according to this preferred embodiment of the present invention, when “in parallel” display is being performed.

### DESCRIPTION OF THE PREFERRED EMBODIMENTS

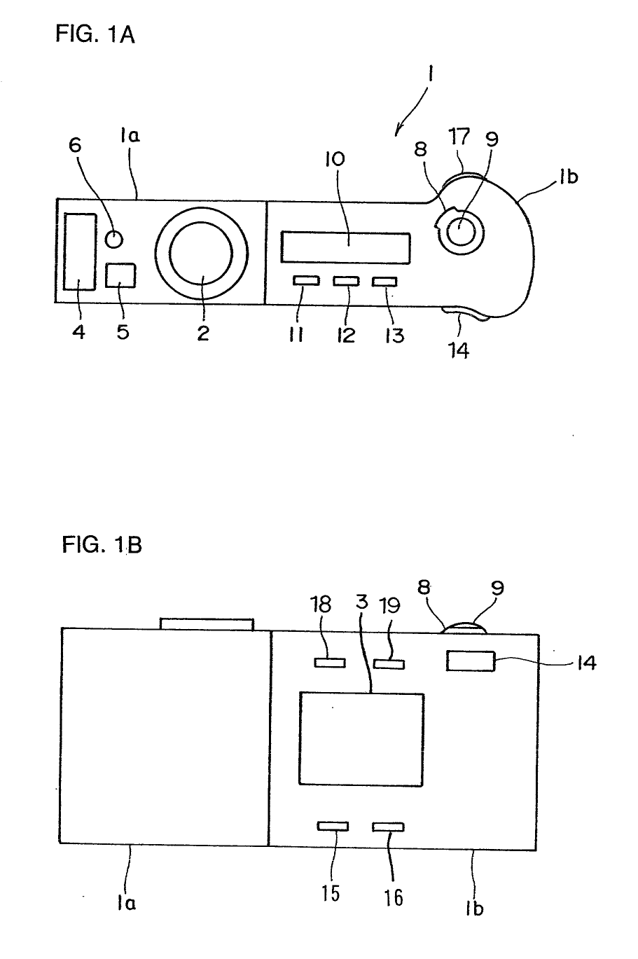

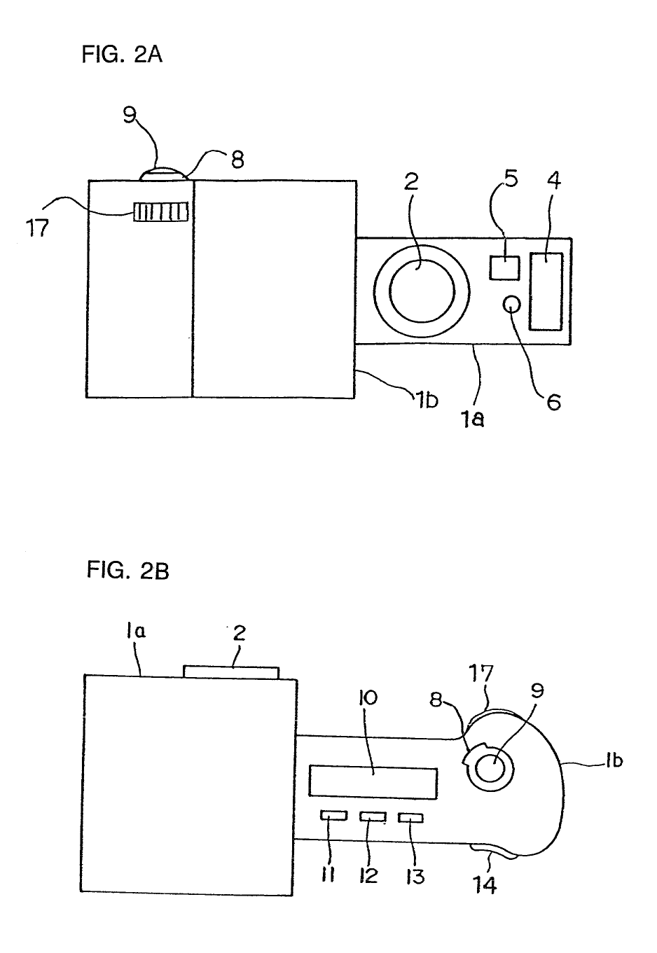

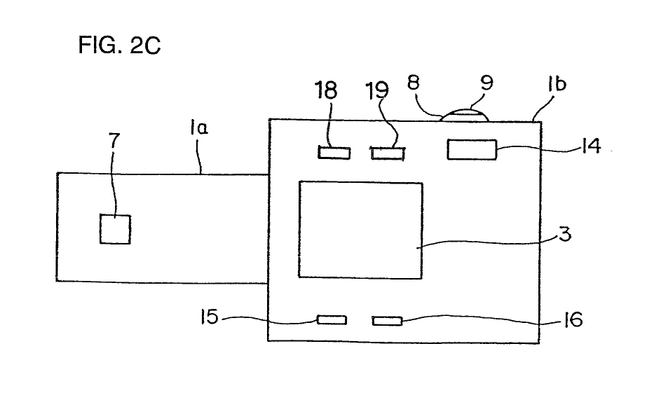

In the following, a preferred embodiment of the present invention will be explained with reference to the drawings. FIGS. 1A and 1B are views showing the exterior of a digital still camera according to this preferred embodiment of the present invention in an unused and portable state, with FIG. 1A being a view as seen from above, while FIG. 1B is a view as seen from the rear. Moreover, FIGS. 2A, 2B, and 2C are views showing the exterior of this digital still camera according to this preferred embodiment of the present invention in a state in which it is ready for normal photography, with FIG. 2A being a view as seen from the front, FIG. 2B being a view as seen from above, and FIG. 2C being a view as seen from the rear. In this digital still camera according to this preferred embodiment of the present invention, a lens unit 1a which comprises a photographic zoom lens 2 is provided separately from a monitor unit 1b which comprises an LCD monitor 3, and these two units 1a and 1b are linked together so as to be rotatable with respect to one another.

In the unused or portable state the lens unit 1a is rotated with respect to the monitor unit 1b so that together they constitute a flat combination, as shown in FIGS. 1A and 1B. Furthermore, in the state for normal photography, as shown in FIGS. 2A, 2B, and 2C the lens unit 1a is rotated with respect to the monitor unit 1b so that the photographic zoom lens faces towards the photographic subject. Thus, at this time, the monitor unit 1b is kept at a position in which the LCD monitor 3 faces towards the photographer, so that he is enabled to perform photography while watching said LCD monitor 3, while the lens unit 1a faces towards the photographic subject.

Apart from the photographic zoom lens 2, the lens unit 1a also comprises an electronic flash device 4, a viewfinder window 5, a red eye reduction and self timer display lamp 6, and a viewfinder eyepiece window 7. On the other hand, apart from the LCD monitor 3, the monitor unit 1b comprises a main switch 8, a release button 9, a display panel 10, a flash photographic mode button 11, a focus mode button 12, a picture quality mode button 13, a zoom changeover button 14, a monitor button 15, a menu button 16, a selection dial 17, an exposure correction button 18, and an exposure mode button 19.

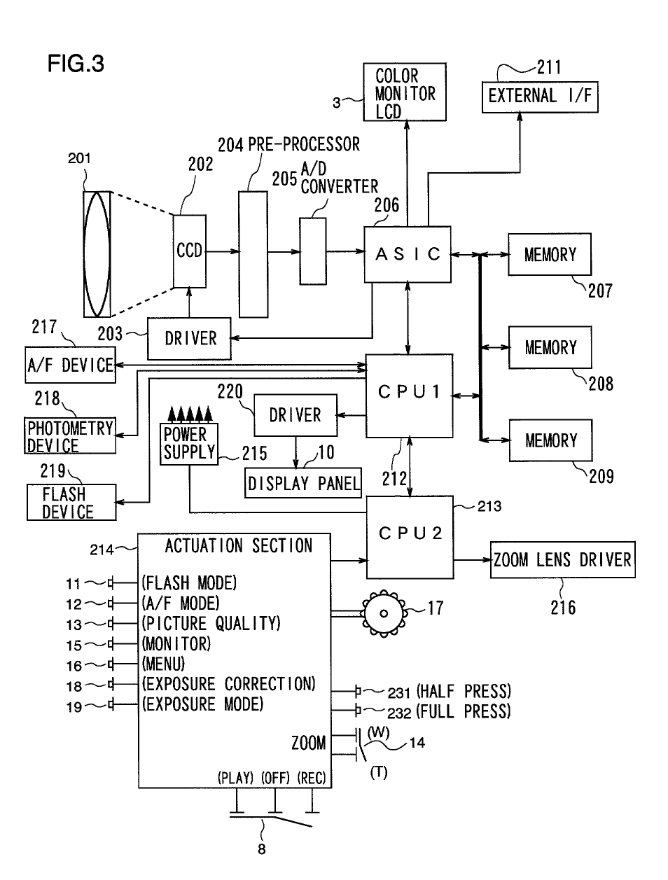

FIG. 3 is a block circuit diagram for this digital still camera 1 according to this preferred embodiment of the present invention. This digital still camera is controlled by a main CPU 212 which controls focus detection and adjustment processing and photometry processing and so on, by an ASIC 206 for image processing which controls image processing and image display processing, and by a CPU 213 for switch control which monitors the input signals from the various switches. Thus, this switch control CPU 213 is constituted so as, when any of the various switches of this digital still camera 1 is actuated, to send information to that effect to the main CPU 212, and also so as, when the zoom changeover button 14 is actuated, to control a zoom lens drive device 216 so as to drive the photographic zoom lens 201 appropriately.

This digital still camera 1 can be set to either a photographic mode (REC) or a replay mode (PLAY) by the photographer changing over the main switch 8. This main switch 8 can be switched over to any one of at least three positions—OFF, REC, and PLAY. The photographic mode is an operational mode in which an image of the photographic subject which has been captured is recorded as image data, while the replay mode is an operational mode in which image data which has been recorded is read out and is displayed upon the LCD color monitor 3. And, in both operational modes, there is provided a menu setting mode for selecting and setting various camera operations. The present explanation will concentrate upon the operation in the photographic mode.

The Photographic Mode

When the main switch 8 is actuated so as to change it over to the photographic mode position, this turns the power supply of the digital still camera ON and changes it to the photographic mode. When the photographic mode is thus selected, light from the photographic subject which is incident upon the photographic zoom lens 201 is focused upon a CCD 202 which is an image capturing device, and an image signal produced thereby is transmitted, via a pre-processor circuit 204 which performs analog processing thereupon, to an A/D conversion circuit which converts it into a digital signal. This signal which has been converted to digital is supplied to the ASIC 206 for image processing, image pre-processing such as contour compensation, gamma correction, and the like is performed upon the signal there, and then the signal is temporarily stored in a memory 207 which is a buffer memory.

This image data which has been stored in the buffer memory 207 is processed into image data for display by the ASIC 206 for image processing. The ASIC 206 for image processing reads out the image data after image pre-processing which is stored in the buffer memory 207, and prepares an image for display by performing subsampling or culling (image size compression processing) according to the display resolution of the LCD color monitor 3. The display image data which have been prepared by the ASIC 206 for image processing is displayed upon the LCD color monitor 3 as a so called “through frame” photographic monitor screen. During this through frame display, by repeating the above described operation, the image upon the LCD color monitor 3 is renewed at a predetermined interval based upon the light from the photographic subject which is incident upon the photographic zoom lens 201.

A half press signal from a half press switch 231 and a full press signal from a full press switch 232 (hereinafter termed the “release switch 232”) are inputted to the switch control CPU 213. These two switches 231 and 232 are operated in association with the release button 9. When the half press signal is inputted by the half press switch 231 being actuated, the switch control CPU 213 transmits a signal to that effect to the main CPU 212, and the A/F device 217 detects the focal adjustment state of the photographic zoom lens 201 according to a command from this CPU 212. The A/F device 217 comprises a light receiving element not shown in the figures which receives light from the photographic subject for focus detection, and a focus adjustment device also not shown in the figures, and, based upon the focus detection data which are detected by the light receiving element for focus detection, the photographic zoom lens 201 is driven to the focused position in which the light from the photographic subject which is incident upon the photographic zoom lens 201 is focused upon the CCD 202. Furthermore, the CCD 202 is driven and controlled via a drive circuit 203, and operation timing of a pre-processor circuit 204 and the A/D conversion circuit 205 are also controlled.

Yet further, when the above described half press signal is inputted to the CPU 212, said CPU 212 also issues a command to the photometry device 218, so as to perform photometry of the brightness of the photographic subject. The photometry device 218 comprises a light reception element not shown in the figures, and, for example, may perform photometry of the brightness of the photographic subject over a detection region for the state of focus adjustment by the above described A/F device 217.

It should be noted that two AF operation modes are provided for this digital still camera 1: the “single A/F” mode and the “continuous A/F” mode. When the “single A/F” mode is set, the focus detection operation by the A/F device 217 is performed upon the actuation of the half press switch 231 as described above, while on the other hand, when the “continuous A/F” mode is set, the focus detection operation by the A/F device 217 is always being performed while the main switch 8 is changed over to the photographic mode position.

When the zoom changeover button 14 is actuated, the zoom lens drive device 216 drives the photographic zoom lens 201 according to a command from the switch control CPU 213, and changes the focal length of said zoom lens 201. The zoom button 14 consists of a seesaw type switch, and can be turned in one direction or the other to either a telescopic side (T) or a wide angle side (W), thus setting the focal length of the zoom lens 201 correspondingly.

When the release switch 232 is turned ON following the actuation of the half press switch 231, light is emitted from the flash device 4 according to the result of photometry by the photometric device 218 and according to the flash mode which has been set in advance by the flash photographic mode button 11, and, by light from the photographic subject via the photographic zoom lens 201 being focused upon the light receiving surface of the CCD 202, signal electric charges are accumulated by the CCD 202 in correspondence to the brightness of the image of the photographic subject. These signal electric charges which have been accumulated by the CCD 202 are emitted out by the driver circuit 203, and are inputted to the pre-processor circuit 204, comprising an AGC circuit and a CDS circuit, which performs analog signal processing thereupon. After analog processing such as gain control and noise elimination and the like have been performed upon the analog image signal by the pre-processor circuit 204, the resulting signal is converted into a digital signal by the A/D conversion circuit 205.

This signal which has been converted into digital form is transmitted to the above described ASIC for image processing 206, wherein it is subjected to image preprocessing such as contour correction and gamma correction and the like, before being temporarily stored in the buffer memory 207. And image data transfer is performed between the CPU 212 and the buffer memory 207, with a white balance adjustment value being received from the stored image data, and white balance adjustment is performed by the ASIC 206 for image processing based upon this adjustment value, and the image data after white balance adjustment is again stored in the buffer memory 207.

Furthermore, format processing (image post-processing) for JPEG compression is then performed by the ASIC 206 for image processing upon the image data which has been subjected to the above type of image pre-processing, so that the image data after this image post-processing is compressed at a predetermined data compression ratio in the JPEG format. A predetermined data file name is appended by the CPU 212 to this image data which has been subjected to compression in the JPEG format, and then it is recorded in a memory 208, which is a recording medium such as a flash memory or the like (a PC card, or a CF card, etc.). When this record processing into the memory 208 has been completed, this photographic processing is terminated.

Additional to the above, a display panel driver circuit 220 is connected to the CPU 212, and the states of a flash emission mode setting of the flash device 4 as set by a flash photographic mode button 11, a distance range setting as set by an A/F mode button 12, a compression ratio setting as set by a picture quality mode button 13, and the like are displayed by this display panel driver circuit 220 upon the display panel 10. Furthermore, an external I/F circuit 211 is connected to the ASIC 206 for image processing, and thereby it is possible to output the display image data as a video signal.

Menu Setting in the Photographic Mode

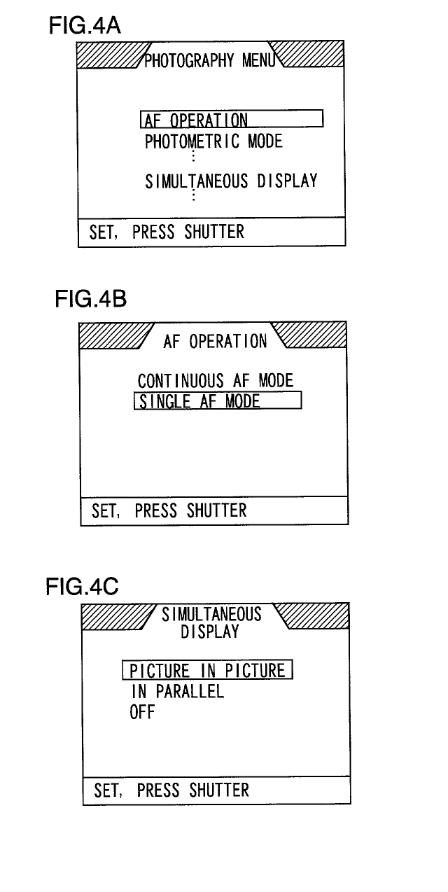

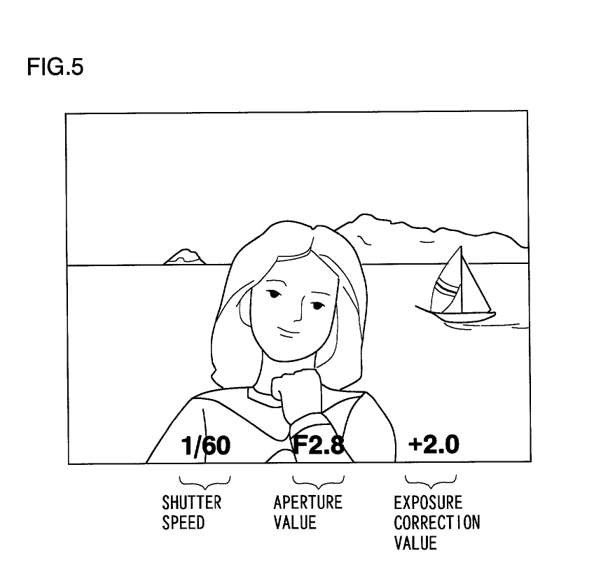

FIGS. 4A, 4B, and 4C are figures for explanation of menu setting screens upon the LCD color monitor 3 for the photographic mode of this digital still camera according to this preferred embodiment of the present invention. When the menu button 16 of FIG. 1B is pressed in the photographic mode, then a photographic menu screen like the one shown in FIG. 4A is displayed upon the LCD color monitor 3 of this digital still camera 1. By actuation of the selection dial 17 or of the zoom changeover button 14 (which functions as a selection switch in the menu setting mode), for example, the item “A/F operation” may be selected from the menu. When the release button 9 (which functions as a selection decision button in the menu setting mode) is pressed and “A/F operation” is selected and confirmed, then a menu setting screen related to the A/F operation mode like the one shown in FIG. 4B is displayed upon the LCD color monitor 3. In this A/F operation mode, as previously described, there are included a “continuous A/F mode” in which focus adjustment operation is always performed while the camera is set to the photographic mode via the main switch 8, and a “single A/F mode” in which focus adjustment is only performed when the half press switch 22 is actuated so as to turn ON.

By actuation of the selection dial 17 or of the zoom changeover button 14, for example, the item “single A/F mode” may be selected from the menu. When the release button 9 is pressed to confirm the selection of “single A/F mode”, then the above described operational mode is selected in which focus detection is only performed when the half press switch 22 is actuated so as to turn ON. This set value becomes effective when the user again presses the menu button 16, so as to return the system from the menu setting mode back to the photographic mode.

When the item “simultaneous display” is selected upon the menu of FIG. 4A, and the selection of this item “simultaneous display” is confirmed by pressing the release button 9, then a menu setting screen like that shown in FIG. 4C related to the simultaneous display mode is displayed upon the LCD color monitor 3. By “simultaneous display” is meant that the through frame before photography and a freeze frame of the image after photography are simultaneously displayed upon the LCD color monitor 3. By actuation of the selection dial 17 or of the zoom changeover button 14, for example, the item “picture in picture” may be selected from the menu. When the release button 9 is pressed to confirm the selection of “picture in picture”, then a display mode is selected in which, superimposed over one of the through frame before photography and the freeze frame of the image after photography, there is displayed a reduced image of the other. Other than this “picture in picture”, it is possible to select “in parallel” in which both of the images are reduced and they are displayed side by side, and “OFF” in which simultaneous display is not performed. The set value becomes effective when the user again presses the menu button 16, so as to return the system from the menu setting mode back to the photographic mode.

The above described menu setting operation for the photographic mode, apart from the “A/F operation” and “simultaneous display” settings explained above, is also used for setting various details of camera operation related to photographic function, such as photometry mode and white balance adjustment value selection and the like. Furthermore, in this menu setting for the photographic mode, there is an item for performing through frame display just as it is, as will now be described. For example, when the selection dial 17 is actuated while the exposure correction button 18 is being pressed, the shutter speed, the aperture value, and the exposure correction value are displayed along the lower portion of the screen, with the through frame display continuing to be performed just as it is, as shown in FIG. 5. When the selection dial 17 is actuated, it is possible to set the exposure correction value. FIG. 5 shows as an example the case in which the exposure correction value has been set to +2.0.

The setting of the shutter speed and the aperture value is performed as follows. When the selection dial 17 is actuated while the exposure mode button 19 is being pressed, the same screen shown in FIG. 5 is displayed as when performing the above described exposure correction. The shutter speed or the aperture value is selected by actuating the selection dial 17 while keeping the exposure mode button 19 pressed, and it is possible to set the shutter speed or the aperture value by actuating only the selection dial 17 within a predetermined time period.

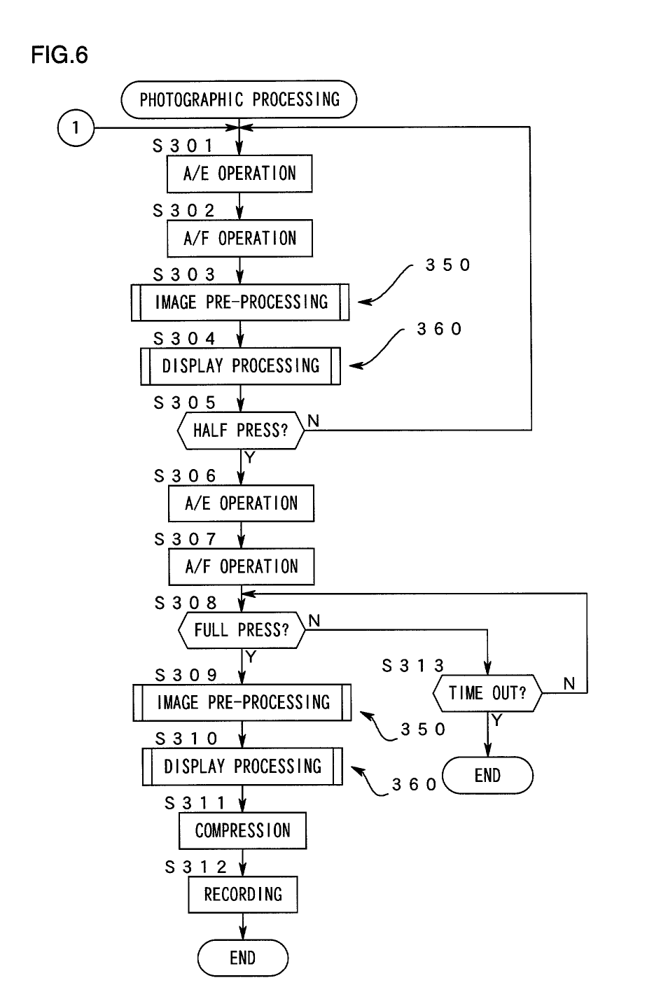

The operation of photographic processing by this digital still camera 1 according to this preferred embodiment of the present invention will now be explained with reference to the flow chart of FIG. 6. When the main switch 8 is actuated and the power supply is turned ON in the photographic mode, this program for photographic processing is started. When the program starts, first in a step S301 exposure adjustment (A/E) is performed based upon the results of photometry by the photometric device 218 (refer to FIG. 3), and next in a step S302 focus detection and focus adjustment (A/F) are performed by the A/F device 217. When the A/F operation has been completed, image pre-processing 350 is performed in a step S303.

When the image pre-processing 350 in the step S303 has been completed, in a step S304 it is processed into image data for display by the ASIC for image processing 206, and a through frame is displayed upon the LCD color monitor 3. Next in a step S305 a decision is made as to whether or not the half press switch 231 is being actuated, and if it is decided that said half press switch 231 is indeed being actuated (the Y result in the step S305) then the flow of control proceeds to a step S306 in which A/E operation for photography is performed; while on the other hand, if it is decided that said half press switch 231 is not being actuated (the N result in the step S305) then the flow of control returns to the step S301. When the A/E operation in the step S306 has been completed, next in a step S307 A/F operation for photography is performed. When this A/F operation has been completed, the results of both of the above described A/E and A/F procedures are stored in the CPU 212, and next in a step S308 a check is performesd as to whether or not the full press switch 232 is being actuated.

If it is decided that the full press switch 232 is indeed being actuated (the Y result in the step S308) then in a step S309 image pre-processing 350 is performed. This image pre-processing 350 is the same procedure as the image pre-processing 350 which was performed in the step S303. When the image pre-processing in the step S309 has been completed, in a next step S310 it is processed into image data for display by the ASIC for image processing 206, and the screen which has been photographed (freeze frame) is displayed upon the LCD color monitor 3. In the next step S311, the image data upon which image pre-processing has been performed is post-processed by being subjected to data compression at a predetermined compression ratio in the JPEG format. And in a next step S312 a predetermined image data filename is appended by the CPU 212 to the image data after compression, and it is recorded in the memory 208; and then the photographic processing routine of FIG. 6 terminates.

On the other hand, if in the above described step S308 it is decided that the full press switch 232 is not being actuated (the N result in the step S308), then in a step S313 a check is made as to whether time up has occurred or not. If it is decided that time up has not yet occurred (the N result in the step S313), then the results of both the A/E and the A/F procedures are stored in the CPU 212 and the flow of control returns to the step S308, so that the system waits for the full press switch 232 to be actuated. Furthermore, if in the step S313 it is decided that time up has now occurred (the Y result in the step S313), then the photographic processing routine of FIG. 6 terminates.

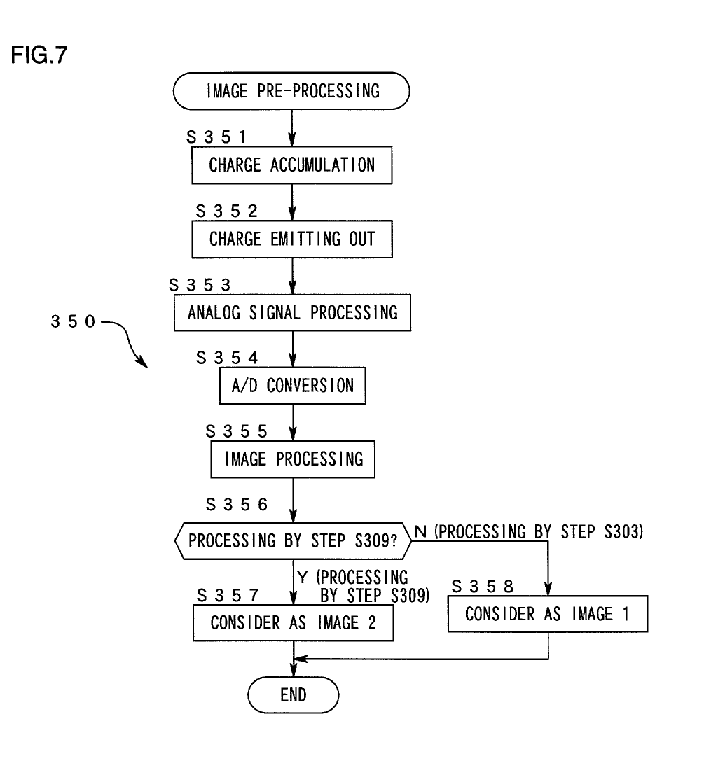

Next, the above described image pre-processing 350 will be explained with reference to the flow chart of FIG. 7. First, in a step S351, electric charges are accumulated in the CCD 202 (refer to FIG. 3) corresponding to the brightness of the image of the photographic subject, and next in a step S352 the electric charges which have been accumulated are emitted out in order and are inputted to the pre-processor circuit 204. Next in a step S353 analog signal processing is performed by the pre-processor circuit 204, and then in a next step S354 the resultant analog signal is converted into a digital signal by the A/D conversion circuit 205. This image signal which has been digitalized is subjected to contour correction and gamma correction by the ASIC 206 for image processing, and then, after having been temporarily stored in the buffer memory 207, is subjected to image processing such as white balance adjustment and the like.

Next, in a step S356, a decision is made as to whether or not the processing of the step S309 is taking place. If it is decided that the processing of the step S309 is taking place (the Y decision in the step S356), then the image data after image processing is considered as being “image 2”, and is written into a region for “image 2” in the buffer memory 207 in a step S357, and then this image pre-processing 350 is terminated. On the other hand, if it is decided that the processing of the step S303 is taking place (the N decision in the step S356), then the image data after image processing is considered as being “image 1”, and is written into a region for “image 1” in the buffer memory 207 in a step S358, and then this image pre-processing 350 is terminated. “Image 2” and “image 1” are names which are appended for the sake of convenience in order to distinguish “image 2” which is the image data which has been captured after the full press switch 232 has been actuated, from “image 1” which is the image data which was captured before the half press switch 231 was actuated.

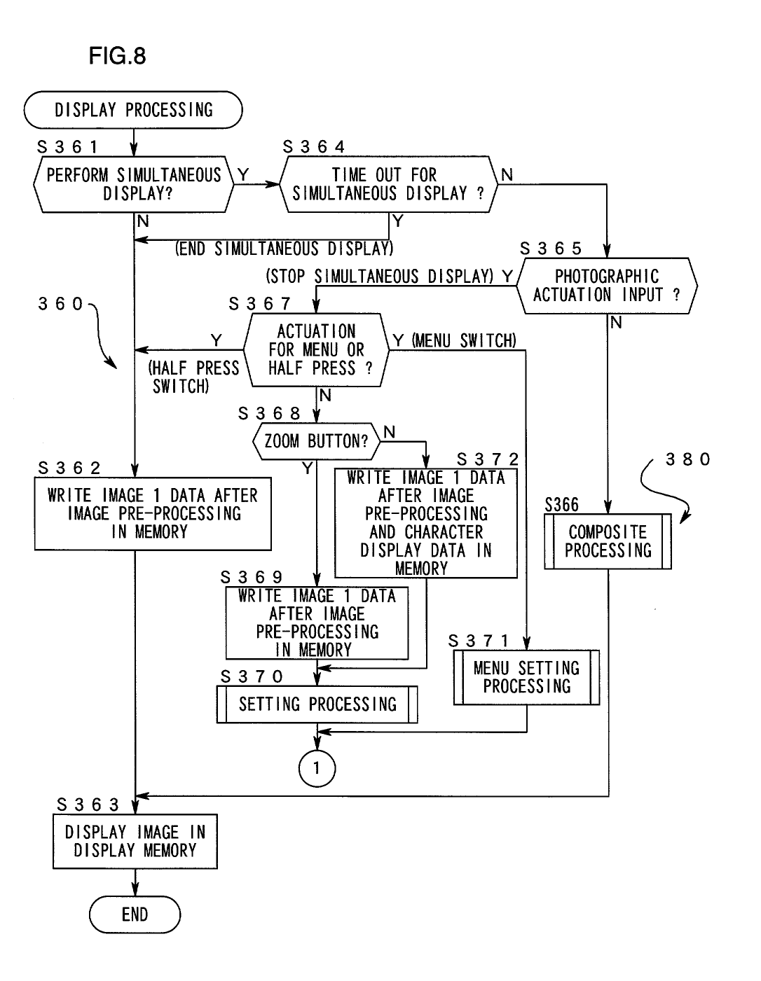

Next, the above described display processing 360 will be explained with reference to the flow chart of FIG. 8. First, in a step S361, a decision is made as to whether or not “image 1” and “image 2” are to be displayed simultaneously upon the LCD color monitor 3. The setting for simultaneous display as picture in picture is performed in advance in the menu setting mode, as has been explained previously. If, based upon the details which have been set in advance in the menu setting mode, it is decided that simultaneous display of “image 1” and “image 2” is not to be performed (the N decision in the step S361), then the data for “image 1” which has been subjected to image pre-processing and has been stored in the buffer memory 207 is subjected to subsampling processing according to the display resolution of the LCD display monitor 3, and is written into the display region of the buffer memory 207 in a step S362. Then in a step S363 the image data which has been written into the display region of the buffer memory 207 is displayed upon the LCD color monitor 3.

On the other hand if, based upon the details which have been set in advance by the menu processing, it is decided that simultaneous display of “image 1” and “image 2” is indeed to be performed (the Y decision in the step S361), then in a step S364 it is decided whether or not time out has occurred. If it is decided that the time period for simultaneous display set in advance to be performed, which may for example be 10 seconds from the start of simultaneous picture in picture display, has elapsed (the Y decision in the step S364) then the flow of control is transferred to the step S362 in order to terminate simultaneous display. On the other hand, if it is decided that 10 seconds has not yet elapsed (the N decision in the step S364) then in a step S365 a decision is made as to whether or not photographic actuation has been performed. If it is decided that photographic actuation has not been performed (the N decision in the step S365) then in a step S366 processing 380 is performed for composing or synthesizing the data for “image 1” and “image 2”, and when this composite processing has been completed the flow of control is transferred to the step S363.

It should be understood that, although in the above described step S364 the time period which was utilized for decision was 10 seconds, it would be acceptable for it to be arranged to be possible to change this to any time period. In such a case, it would be arranged to set this time period simultaneously when selecting “picture in picture” or “in parallel” under the menu item “simultaneous display” during the menu setting in advance. Furthermore, the above described time measurement operation is performed by frequency dividing an operational clock signal which is inputted to the CPU 212 by using a counter circuit or the like not shown in the figures.

If in the above step S365 it is decided that photographic actuation has indeed been performed (the Y decision in the step S365), then, in order to stop the simultaneous display, then in a step S367 a check is made as to whether or not either the menu switch 16 or the half press switch 231 has been actuated. If it is decided that the half press switch 231 has been actuated then the flow of control is transferred to the step S362, while if it is decided that the menu switch 16 has been actuated, then in a step S371 menu setting processing for the photographic mode is performed. In this menu setting processing, the display upon the LCD color monitor 3 is changed over to an actuation menu display like those shown in FIGS. 4A, 4B, and 4C, and the details of setting of the digital camera 1 are changed from among the displayed items, as described previously. After the changing of the setting details has been completed, in order to change over the menu display screen to the display of “image 1”, the data for “image 1” which is stored in the buffer memory 207 is processed by being subsampled or thinned out corresponding to the display resolution of the LCD color monitor 3, and is written into the display region of the buffer memory 207, and then the flow of control is returned to the step S301 of the flow chart shown in FIG. 6.

On the other hand, if in the step S367 it is determined that neither the menu switch 16 nor the half press switch 231 has been actuated (the N decision in the step S367), then in a step S368 a decision is made as to whether or not it is the zoom button 14 which has been actuated. If in the step S368 it is determined that the zoom button has been actuated (the Y decision in the step S368), then, since the character display at the lower edge of FIG. 5 is not required, then in a step S369 only the data for “image 1” which has been subjected to image pre-processing and is stored in the buffer memory 207 is processed by being subsampled according to the display resolution of the LCD color monitor 3, and is written into the region for display in the buffer memory 207.

On the other hand, if in the step S368 it is decided that the zoom button 14 has not been actuated (the N decision in the step S368), then, since it is either simultaneous actuation of the exposure correction button 18 and the selection dial 17 or simultaneous actuation of the exposure mode button 19 and the selection dial 17 which have been performed, therefore in a step S372 the data for “image 1” which have been subjected to image pre-processing and is stored in the buffer memory 207 and character display data showing the shutter speed, the aperture opening value, and the exposure correction value are written into the region for display in the buffer memory 207. FIG. 5 is an example of display upon the LCD color monitor 3 of the data for “image 1” which has been written into the display region of the buffer memory 207 and the character display data. It should be understood that the data for “image 1” is processed by being subsampled according to the display resolution of the LCD color monitor 3, as described above, and is written into the region for display in the buffer memory 207.

When the alteration of the setting details has been completed by setting processing which corresponds to the various actuation buttons described above, then in a step S370 the data for “image 1” which has been processed by being subsampled in correspondence to the display resolution of the LCD color monitor 3 is rewritten into the region for display of the buffer memory 207, and then the flow of control is returned to the step S301 of the flow chart of FIG. 6.

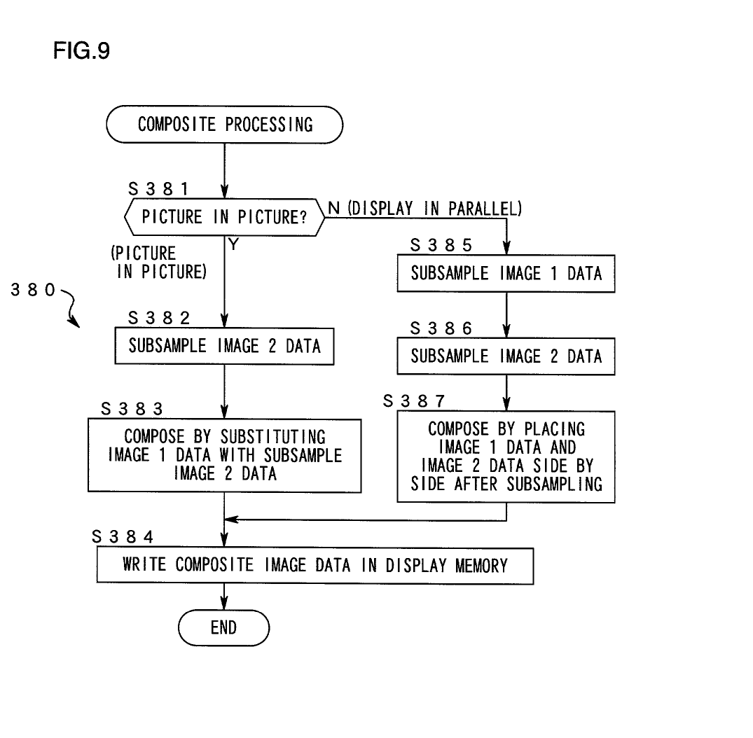

Next, the above described composite processing 380 will be explained with reference to the flow chart of FIG. 9. First, in a step S381, a decision is made as to whether or not “picture in picture” display is to be performed. The setting for performing “picture in picture” display will have been performed in advance in the menu setting mode, as described above. If, based upon the details which have been set in the menu setting mode, it is decided that “picture in picture” display is to be performed (the Y decision in the step S381), then in a step S382 the data for “image 2” which has been subjected to image pre-processing and is stored in the region for “image 2” in the buffer memory 207 is copied into a region for composite processing in the buffer memory 207 while processing is performed for subsampling it based upon a predetermined compression ratio, for example so that its display area should be reduced to 1/9 of the original. It should be understood that, if no data for “image 2” after image pre-processing is stored in the region for “image 2” of the buffer memory 207, then no subsampling processing is performed.

Next, in a step S383, the data for “image 1” which is stored in the region for “image 1” in the buffer memory 207 is copied into the region for composite processing in the buffer memory 207. At this time, this copy is performed while composing it with the data for “image 2” which has been processed by being subsampled so that, for example, its display area is reduced to 1/9 of the original, as described above. In other words, composition (superimposition) is performed so as to overwrite a portion of the data for “image 1” with the compressed or reduced data for “image 2”. The composite image which has been thus composed in the composite processing region of the buffer memory 207 is processed in a next step S384 by being subsampled according to the display resolution of the LCD color monitor 3, and is then written into the region for display of the buffer memory 207; and then the composite processing of FIG. 9 is terminated. It should be understood that, when no subsampling processing is performed in the step S382 due to the absence of stored data for “image 2”, the data for “image 1” is processed by being subsampled according to the display resolution of the LCD color monitor 3, and is then written into the region for display of the buffer memory 207.

On the other hand, if, based upon the details which have been set in the menu setting mode, it is decided that “picture in picture” display is not to be performed (the N decision in the step S381), then in a step S385 the data for “image 1” which has been subjected to image pre-processing and is stored in the region for “image 1” in the buffer memory 207 is copied into the region for composite processing in the buffer memory 207 while processing is performed for subsampling it based upon a predetermined compression ratio, for example so that its display area should be reduced to ¼ of the original. Next, similarly, in a step S386 the data for “image 2” which has been subjected to image pre-processing and is stored in the region for “image 2” in the buffer memory 207 is copied into the region for composite processing in the buffer memory 207 while processing is performed for subsampling it based upon a predetermined compression ratio, for example so that its display area should be reduced to ¼ of the original.

Next, in a step S387, the data for “image 1” and the data for “image 2” which have been subjected to subsampling processing in the composite region of the buffer memory 207 are composed in the region for composite processing so as to be “in parallel”. In other words, both of the sets of image data are composed so as to display all of the data for “image 1” and all of the data for “image 2” at the same size “in parallel”.

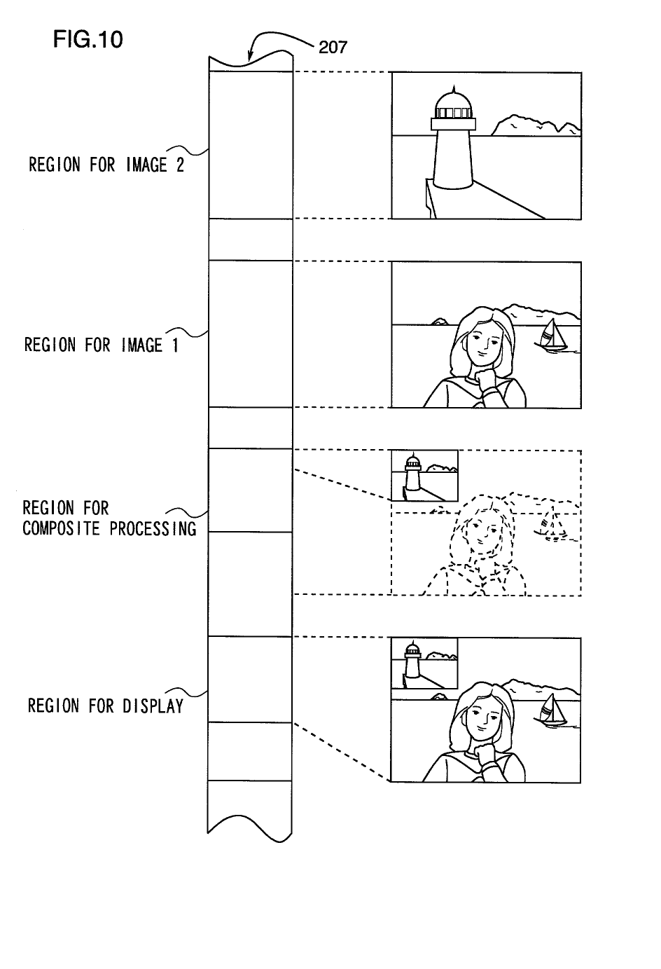

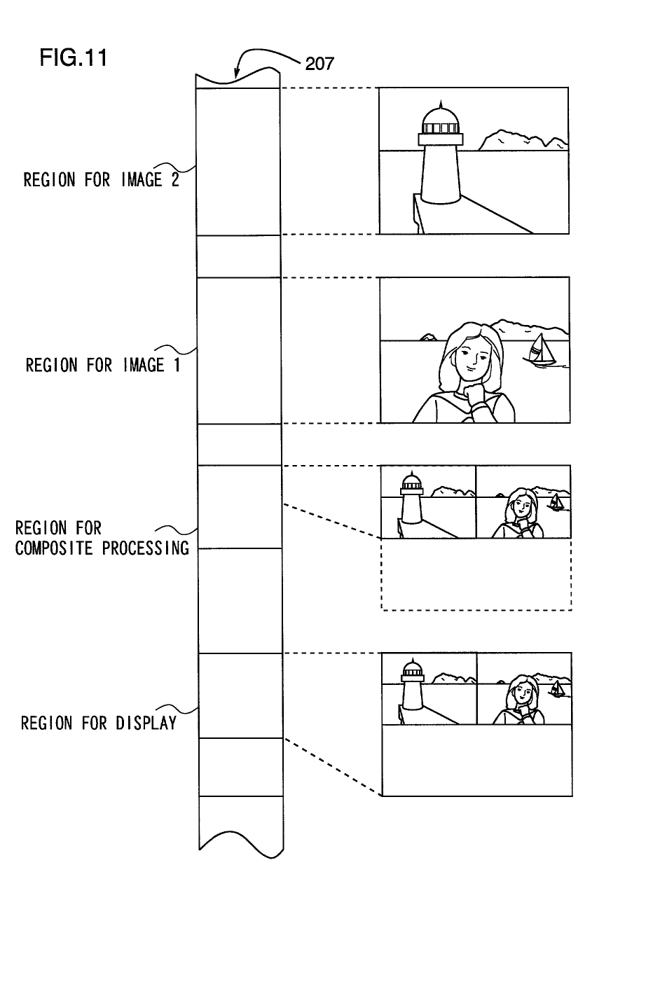

FIGS. 10 and 11 are figures for explanation of a portion of the map which is allocated in the buffer memory 207 as described above. FIG. 10 relates to the case when “picture in picture” display is being performed, while FIG. 11 relates to the case when “in parallel” display is being performed. In FIGS. 10 and 11, the interior of the buffer memory 207 is shown as being divided into at least a storage region dedicated to the data for “image 2” and the data for “image 1”, a composite processing region for reducing or compressing and composing the data for “image 1” and the data for “image 2”, and a region for display in which display image data is stored after having been processed by being subsampled according to the display resolution of the LCD color monitor 3. Examples of the images which are stored in each region are shown on the right sides of these figures. In FIGS. 10 and 11, the image which is displayed upon the LCD color monitor 3 of the digital camera 1 is the image whose data is stored in the display region which is shown at the lowermost positions in these figures.

To explain the outstanding characteristic of this preferred embodiment, since it is arranged to display the data for image 2 which is the photographed screen (the freeze frame) as superimposed over the data for “image 1” which is the through frame, thereby it is possible for the user to check the “image 2” which has been photographed while checking the image “image 1” of the photographic subject which is to be photographed next. As a result, for example, even if the same photographic subject is to be photographed, it is possible to determine upon the composition of the next photograph while comparing and checking against the composition of the screen of “image 2” which has been photographed.

Furthermore, since the data for “image 2” is displayed as compressed or reduced in relation to the data for “image 1”, the possibility is prevented of the display screen for the data for “image 1” not being able to be checked due to its being hidden under the data for “image 2”.

Yet further, since it is arranged that the time period over which the simultaneous display of the data for “image 2” and the data for “image 1” is performed can be altered, therefore it becomes possible to adjust the display time according to the desire of the photographer, and accordingly the convenience of use of the camera is enhanced.

And, since it is arranged that the simultaneous display of the data for “image 2” and the data for “image 1” is stopped when menu setting and photographic actuation are performed, therefore the possibility is prevented of menu setting actuation and photographic actuation becoming hard to perform due to simultaneous display being performed.

Although in the above explanation, during “picture in picture” display, it was arranged for a portion of the data for “image 1” to be replaced by the data for “image 2” which was compressed or reduced, it would also be acceptable, conversely, for a portion of the data for “image 2” to be replaced by the data for “image 1” which is reduced or compressed.

Furthermore although, in the above explanation, the reduction ratio for the data for “image 2” during “picture in picture” display was arranged to be 1/9, it would be acceptable to arrange for this value to be variable. Yet further, it would also be acceptable to set display at the same magnification without reduction, and in such a case, in the step S364 during “picture in picture” display, the data for “image 2” is displayed instead of the data for “image 1” during the period of 10 seconds until it is decided that time out for simultaneous display has occurred.

Although the time period for deciding upon time out in the above described step S364 was arranged to be 10 seconds, it could also be changed to any time period, such as for example 5 seconds or 20 seconds or the like, and furthermore it could also be set to be infinite. In such a case, the simultaneous display would be terminated by a Y decision being made in the step S365 during simultaneous display of the data for “image 1” and the data for “image 2”.

Yet further, although in the above explanation the data for “image 2” was arranged to be a freeze frame which was a photographed screen, it would also be acceptable to arrange to display a photographic subject image of the region for detection of the focus adjustment state during A/F operation, instead of a photographed screen. In such a case, since “picture in picture” display is performed of the image of the A/F operation region superimposed over the data for “image 1” which is the through frame, accordingly it is easy for the photographer to understand with respect to which portion of “image 1” the A/F operation is being performed.

Although the above explanation has been made in terms of an electronic still camera which is capable of displaying a through frame and a freeze frame, the present invention can also be applied to a video camera which displays a moving image and a still image. Furthermore, although the above explanation has been made in terms of an electronic still camera which comprises a display device which displays an image, the present invention can also be applied to an electronic still camera which outputs an image signal for display upon a monitor device which is provided externally.

What is claimed is:

1. An electronic still camera, comprising:
an image capturing element which captures an image of a photographic subject via a photographic lens, and which outputs the image of the photographic subject which has been captured as image data;
a storage device which stores at least two sets of image data having different image capture timings;
a display device which displays an photographic subject image which has been converted into image data; and
a display control circuit which, during photography, causes at least two photographic subject images based respectively upon said two sets of image data to be displayed upon said display device in different regions thereof.

2. An electronic still camera according to claim 1, further comprising:
an image size compression circuit which compresses an image size of image data for displaying a photographic subject image upon said display device, wherein
said image size compression circuit compresses image sizes of said two sets of image data into two different sizes while maintaining aspect ratios of the image sizes of said two sets of image data constant.

3. An electronic still camera according to claim 1, wherein one of said two sets of image data is a photographic subject image which has been captured upon shutter release actuation, and the other is a photographic subject image which is being captured by said image capturing element.

4. An electronic still camera according to claim 2, wherein said image size compression circuit makes the image size of said photographic subject image which is being captured by said image capturing element to be larger, than the image size of said photographic subject image which has been captured upon shutter release actuation.

5. An electronic still camera according to claim 1, further comprising:
a selection device which selects a recording mode in which, upon shutter release actuation, a photographic subject image is captured and image data is recorded, and a replay mode in which image data which has been recorded in recording mode is displayed upon said display device, wherein
if the recording mode is selected by said selection device, said display control circuit displays said at least two photographic subject images based respectively upon said two sets of image data upon said display device in different regions thereof.

6. An electronic still camera according to claim 5, further comprising:
a recording medium, separate from said storage device, upon which image data is recorded, wherein
said recording medium records image data during the recording mode, and reads out image data which has been recorded during the replay mode.

7. An electronic still camera according to claim 1, wherein said display device is provided within the same chassis as the electronic still camera.

8. An electronic still camera, comprising:
an image capturing element which captures an image of a photographic subject via a photographic lens, and which outputs the image of the photographic subject which has been captured as image data;
a storage device which stores at least two sets of image data having different image capture timings;
a display device which displays an photographic subject image which has been converted into image data; and
a display control circuit which, during photography, provides a display upon said display device which is changeable over between a multi image display in which at least two photographic subject images based respectively upon said two sets of image data are displayed, and a single image display in which one or the other of said at least two photographic subject images based respectively upon said two sets of image data is displayed.

9. An electronic still camera according to claim 8, further comprising:
a selection device which selects either the multi image display or the single image display.

10. An electronic still camera according to claim 9, further comprising:
a time measurement circuit which times a time period during which the multi image display is performed, wherein
in a case that the multi image display is selected by said selection device, said display control circuit stops the multi image display and changes over to the single image display, when a predetermined time period after the multi image display has been selected has been timed by said time measurement circuit.

11. An electronic still camera according to claim 9, further comprising:
a decision circuit which decides whether or not at least half press shutter release actuation has been performed, wherein
in a case that the multi image display is selected by said selection device, said display control circuit stops the multi image display and changes over to the single image display, when it has been decided by said decision circuit that half press shutter release actuation has been performed.

12. An electronic still camera according to claim 8, wherein one of said two sets of image data is a photographic subject image which has been captured upon shutter release actuation, and the other is a photographic subject image which is being captured by said image capturing element.

13. An electronic still camera according to claim 8, further comprising:
a selection device which selects a recording mode in which, upon shutter release actuation, an image of a photographic subject is captured and image data is recorded, and a replay mode in which image data which has been recorded in recording mode is displayed upon said display device, wherein
if the recording mode is selected by said selection device, said display control circuit provides a display upon said display device which is changeable over between a multi image display in which at least two photographic subject images based respectively upon said two sets of image data are displayed, and a single image display in which one or the other of said at least two photographic subject images based respectively upon said two sets of image data is displayed.

14. An electronic still camera according to claim 13, further comprising:
a recording medium, separate from said storage device, upon which image data is recorded, wherein
said recording medium records image data during the recording mode, and reads out image data which has been recorded during the replay mode.

15. An electronic still camera according to claim 8, wherein said display device is provided within the same chassis as the electronic still camera.
